(19) United States
(12) Patent Application Publication
(10) Pub. No.: US 2025/0187398 A1
(43) Pub. Date: Jun. 12, 2025

(54) HEAT PUMP SYSTEM FOR VEHICLE

(71) Applicant: Hanon Systems, Daejeon (KR)

(72) Inventors: Dae Woong LEE, Daejeon (KR); Jae Chun YOU, Daejeon (KR); Sang Gu WOO, Daejeon (KR); Yu Ho LEE, Daejeon (KR)

(21) Appl. No.: 18/845,970

(22) PCT Filed: Jun. 20, 2023
(86) PCT No.: PCT/KR2023/008520

§ 371 Date: Sep. 11, 2024

(30) Foreign Application Priority Data
Jul. 14, 2022 (KR) 10-2022-0087206

(51) Int. Cl. B60H 1/00

(52) U.S. Cl. CPC B60H 1/00899

(57) ABSTRACT

A heat pump system for a vehicle, which has the great advantage of improving air conditioning efficiency, enabling most of an air cooled condenser to be reduced compared to a conventional condenser, and reducing cost and a package size. A heat pump system for a vehicle comprises a refrigerant line circulating through a compressor, an outdoor heat exchanger, an expansion means, and an indoor heat exchanger in which refrigerant circulates through the indoor heat exchanger and exchanges heat with air discharged thereinto; a first cooling water line which circulates through an engine, an engine radiator, and a heater core in which cooling water circulates through the heater core and exchanges heat with air discharged thereinto; and a second cooling water line circulating through electric components and an electric radiator, which includes a valve part for connecting or separating the first cooling water line and the second cooling water line.

### TECHNICAL FIELD

The present invention relates to a heat pump system for a vehicle, and more specifically, to a heat pump system for a vehicle installed in a hybrid vehicle to heat the interior without operating an engine in cold environments.

### BACKGROUND ART

In general, an air conditioner for a vehicle includes a cooling system for cooling the interior of the vehicle, and a heating system for heating the interior of the vehicle. The cooling system, at an indoor heat exchanger side of a refrigerant cycle, converts the air passing the outside of an indoor heat exchanger into cold air by exchanging heat between the air and refrigerant flowing inside an evaporator. Moreover, the heating system, at a heater core side of a cooling water cycle, converts the air passing the outside of the heater core into warm air by exchanging heat between the air and cooling water flowing inside the heater core to heat the interior of the vehicle.

On the other hand, an electric vehicle uses a heat pump system in which the vapor compression cycle is formed in a reverse way. In this case, such a heat pump system focuses on a module for the distribution and supply of low-temperature cooling water to improve the driving range based on electric waste heat, so has disadvantages in that it is difficult to be used in low outdoor temperature environments and the heat pump system must run in parallel with a high-capacity PTC heater to perform heating.

Referring to FIG. 1, the heat pump system installed in a conventional hybrid electric vehicle (HEV) comprises a compressor 8, an outdoor heat exchanger 6, an expansion valve 5, and an evaporator 3. Additionally, an accumulator 9 is provided upstream of the compressor 8 in a refrigerant flow direction. Moreover, the high-temperature and high-pressure refrigerant discharged from the compressor 8 is circulated by sequentially passing through the outdoor heat exchanger 6, the expansion valve 5, the evaporator 3, and the accumulator 9.

An evaporator 3 and a heater core 4 are sequentially equipped inside an air flow passage in an air conditioning case 1 in the air flow direction. The evaporator 3 exchanges heat with the air passing through the evaporator 3, and the heater core 4 exchanges heat with the air passing through the heater core 4 to heat the air. A temperature door 2 is provided between the indoor heat exchanger 3 and the heater core 4 to adjust the air temperature. A PTC heater 7 may be further provided downstream of the heater core 4 in the air flow direction.

Meanwhile, a cooling water line passing through an engine 13 goes through a water pump 16, a reservoir tank 15, and then, passes through a radiator 14. The waste heat from the engine 13 exchanges heat with the outdoor air in the radiator 14 to be cooled. Additionally, a portion of the cooling water line that passes through the engine 13 passes through a water pump 11 and the heater core 4, and then, circulates through the engine 13. The high-temperature cooling water, which cooled the engine 13, exchanges heat with the air being discharged into the interior in the heater core 4 to perform heating.

In addition, a reservoir tank 18, a water pump 19, and a low-temperature radiator 20 are provided in another cooling water line passing through electric components 17, such as a PE module and the like, to circulate cooling water. The heat pump system for a vehicle installed in the hybrid vehicle actuates the engine 13 to heat the cooling water for performing heating, and performs cooling through a vapor compression cooling cycle using the compressor 8.

The conventional heat pump system for the vehicle installed in the hybrid vehicle has to operate the engine continuously since performing heating by heating the cooling water for winter heating, resulting in poor low-temperature fuel efficiency and high carbon dioxide emissions. Additionally, it takes much time to heat cooling water and supply the heated cooling water to the heater core, and in this instance, the comfort of passengers inside the vehicle is reduced. Furthermore, as a test result in a fuel efficiency evaluation mode, fuel efficiency is reduced by 7% at low temperature of −7° C. compared to room temperature. In this instance, the air conditioner is operated, the fuel efficiency is reduced by up to 25%.

### DISCLOSURE

### Technical Problem

Accordingly, the present invention has been made in view of the above-mentioned problems occurring in the related art, and it is an object of the present invention to provide a heat pump system for a vehicle, which has improved air conditioning efficiency, can considerably reduce the size of an air-cooled condenser, and greatly reduce cost and a package size.

### Technical Solution

To accomplish the above-mentioned objects, according to the present invention, there is provided a heat pump system for a vehicle including: a refrigerant line which circulates through a compressor, an outdoor heat exchanger, an expansion means, and an indoor heat exchanger, and in which refrigerant circulating through the indoor heat exchanger exchanges heat with air discharged to the interior; a first cooling water line which circulates through an engine, an engine radiator, and a heater core, and in which cooling water circulating through the heater core exchanges heat with air discharged to the interior; and a second cooling water line which circulates through electric components and an electric radiator, wherein a valve part for connecting or separating the first cooling water line and the second cooling water line is provided.

The valve part includes: a first three-way valve which allows or blocks the flow of cooling water from the second cooling water line to the first cooling water line; and a second three-way valve which allows or blocks the flow of cooling water from the first cooling water line to the second cooling water line.

The heat pump system for a vehicle further includes: a water-cooled condenser which is provided between the compressor and the outdoor heat exchanger to exchange heat between the refrigerant and either the engine heat from the first cooling water line or the electric heat from the second cooling water line; and a chiller which is provided upstream of the compressor in a refrigerant flow direction to exchange heat between the refrigerant and the electric heat from the second cooling water line.

The water-cooled condenser is arranged parallel to the engine and the heater core.

The heat pump system for a vehicle further includes: a third three-way valve which is provided downstream of the first three-way valve in a cooling water flow direction to allow the cooling water passing through the first three-way valve to flow to the engine or the water-cooled condenser; and a fourth three-way valve which is provided upstream of the second three-way valve in the cooling water flow direction to allow cooling water passing through the engine to flow to the second three-way valve or allow cooling water passing through the water-cooled condenser to flow to the second three-way valve.

The first three-way valve branches off between the electric radiator and the electric components and is connected between the heater core and the third three-way valve in the first cooling water line, and the second three-way valve branches off between the fourth three-way valve and the heater core and is connected between the chiller and the electric radiator in the second cooling water line.

The heat pump system for a vehicle further includes: a first expansion valve which selectively makes the refrigerant expand or bypass between the compressor and the outdoor heat exchanger, wherein the water-cooled condenser is positioned between the compressor and the first expansion valve.

The heat pump system for a vehicle further includes: a second expansion valve which selectively makes the refrigerant expand between the outdoor heat exchanger and the indoor heat exchanger or change the direction toward the chiller, wherein the chiller is arranged between the second expansion valve and the compressor, so the refrigerant passing through the outdoor heat exchanger circulates through the compressor after sequentially passing through the second expansion valve and the indoor heat exchanger or circulates through the compressor after passing through the chiller.

The heat pump system for a vehicle further includes: a fifth three-way valve which controls the cooling water passing through the chiller in the second cooling water line to selectively pass through or bypass the electric radiator.

In a cooling mode, when the engine is off, the first cooling water line and the second cooling water line are connected by the control of the first three-way valve and the second three-way valve, so the water-cooled condenser is cooled using the electric radiator.

In the cooling mode, at the initial operation of the engine, the water-cooled condenser is cooled using the cooling water circulating through the engine in the first cooling water line, so cooling is performed using the water-cooled condenser and the outdoor heat exchanger. In the cooling mode, when the engine is operating, the flow passage of the water-cooled condenser is blocked, so cooling is performed using only the outdoor heat exchanger.

In a heating mode, when the engine is off, the first cooling water line and the second cooling water line are separated from each other by the control of the first three-way valve and the second three-way valve, so the cooling water in the first cooling water line, heated by the refrigerant in the water-cooled condenser, is supplied to the heater core to perform heating, and the cooling water in the second cooling water line, passing through the electric components, is cooled in the chiller.

In the heating mode, when the engine is operating, the first cooling water line and the second cooling water line are separated from each other by the control of the first three-way valve and the second three-way valve, so the cooling water in the first cooling water line, heated by the engine, is supplied to the heater core to perform heating.

In a dehumidification mode, when the engine is off, the first cooling water line and the second cooling water line are separated from each other by the control of the first three-way valve and the second three-way valve, so the cooling water in the first cooling water line, heated by the refrigerant in the water-cooled condenser, is supplied to the heater core to perform heating, and the cooling water in the second cooling water line, passing through the electric components, is cooled in the chiller, wherein the refrigerant in the refrigerant line, expanded by passing through the outdoor heat exchanger, is evaporated in the indoor heat exchanger and circulates through the compressor.

In the dehumidification mode, when the engine is operating, the first cooling water line and the second cooling water line are separated from each other by the control of the first three-way valve and the second three-way valve, so the cooling water in the first cooling water line, heated by the engine, is supplied to the heater core to perform heating, wherein the refrigerant in the refrigerant line, expanded by passing through the outdoor heat exchanger, is evaporated in the indoor heat exchanger and circulates through the compressor.

In another aspect of the present invention, there is provided a heat pump system for a vehicle including: a refrigerant line which circulates through a compressor, an outdoor heat exchanger, an expansion means, and an indoor heat exchanger, and in which refrigerant circulating through the indoor heat exchanger exchanges heat with air discharged to the interior; a first cooling water line which circulates through an engine, an engine radiator, and a heater core, and in which cooling water circulating through the heater core exchanges heat with air discharged to the interior; and a second cooling water line which circulates through electric components and an electric radiator, wherein a water-cooled condenser is provided between the compressor and the outdoor heat exchanger, and the water-cooled condenser exchanges heat between the refrigerant and either the engine heat from the first cooling water line or the electric heat from the second cooling water line, so the refrigerant discharged from the compressor is primarily cooled in the water-cooled condenser and secondarily cooled in the outdoor heat exchanger during cooling.

### Advantageous Effect

The heat pump system for the vehicle according to an embodiment of the present invention can heat the interior of a hybrid vehicle without operation of the engine in low-temperature environments by applying the heat pump system to the hybrid vehicle, improve fuel efficiency, reduce carbon dioxide emissions, and enhance the thermal comfort of passengers inside.

Additionally, by integrating the heat pump system with the existing air conditioner using the heater core, the heat pump system for the vehicle according to an embodiment of the present invention can effectively heat the interior even in low-temperature environments as cold as −30° C. since switching to heating using cooling water when the engine is operated.

In addition, the heat pump system has good cooling efficiency by cooling the water-cooled condenser using cooling water of the PE module (electric components) due to the condenser configured to be both air-cooled and water-cooled, and is highly advantageous in terms of cost reduction and vehicle packaging since considerably reducing the size of the air-cooled condenser (outdoor heat exchanger) compared to the existing heat pump system.

### DESCRIPTION OF THE DRAWINGS

FIG. 1 is a conventional heat pump system.

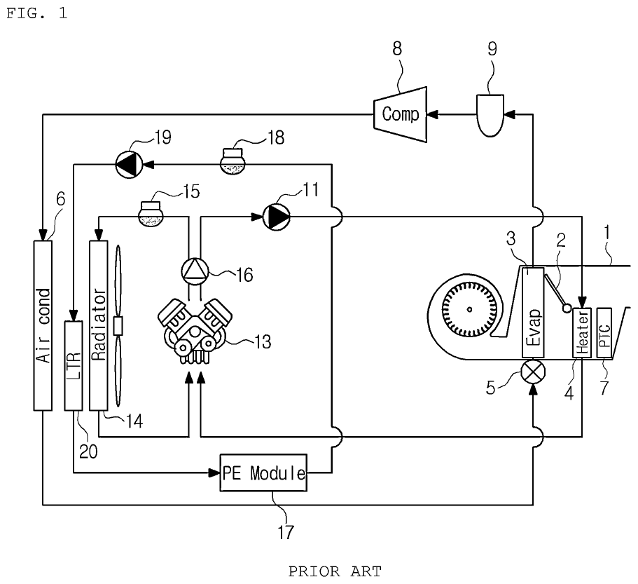

FIG. 2 illustrates a heat pump system for a vehicle according to an embodiment of the present invention.

FIG. 3 illustrates an engine stop condition in a cooling mode of the heat pump system for a vehicle according to an embodiment of the present invention.

FIG. 4 illustrates an initial operation of the engine in the cooling mode of the heat pump system for a vehicle according to an embodiment of the present invention.

FIG. 5 illustrates an engine operation in the cooling mode of the heat pump system for a vehicle according to an embodiment of the present invention.

FIG. 6 illustrates an engine stop condition in a heating mode of the heat pump system for a vehicle according to an embodiment of the present invention.

FIG. 7 illustrates an engine operation in the heating mode of the heat pump system for a vehicle according to an embodiment of the present invention.

FIG. 8 illustrates an engine stop condition in a dehumidification mode of the heat pump system for a vehicle according to an embodiment of the present invention.

FIG. 9 illustrates an engine operation in the dehumidification mode of the heat pump system for a vehicle according to an embodiment of the present invention.

### MODE FOR INVENTION

Hereinafter, referring to attached drawings, a technical configuration of a heat pump system for a vehicle according to an embodiment of the present invention will described in detail as follows.

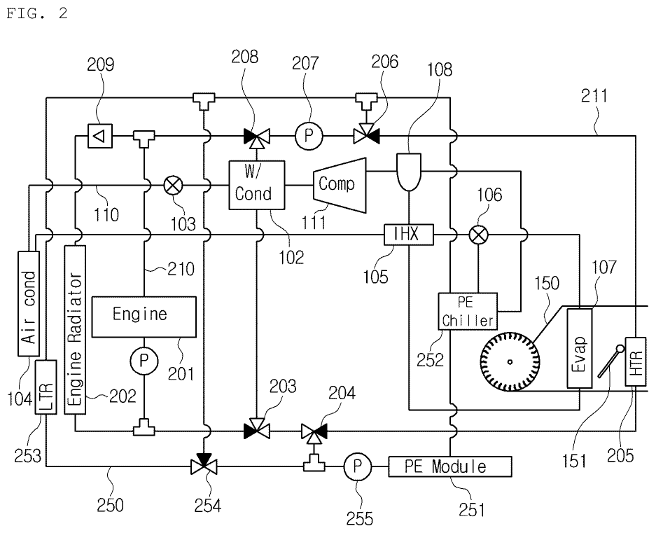

Referring to FIG. 2, the heat pump system for the vehicle according to an embodiment of the present invention is installed in a hybrid vehicle (HEV) having an engine 201 and electric components 251 such as a power electric module (PE module) and the like. The heat pump system for the vehicle includes a refrigerant line 110, a first cooling water line 211, and a second cooling water line 250. In this case, the electric components 251 include the power electric module (PE module) and the like.

The refrigerant line 110 circulates through a compressor 111, an outdoor heat exchanger 104, an expansion means, and an indoor heat exchanger 107. The indoor heat exchanger 107 acts as an evaporator, and the refrigerant circulating through the indoor heat exchanger 107 exchanges heat with the air being discharged into the interior to cool the air. The compressor 111, a water-cooled condenser 102, a first expansion valve 103, the outdoor heat exchanger 104, a second expansion valve 106, the indoor heat exchanger 107, and an accumulator 108 are sequentially disposed in the refrigerant line 110 in a refrigerant flow direction.

The compressor 111 compresses and discharges the refrigerant, and an accumulator 108 is provided upstream of the compressor 111 in the refrigerant flow direction. The indoor heat exchanger 107 is located inside an air conditioning case 150 to exchange heat between the refrigerant and the air inside the air conditioning case 150. The outdoor heat exchanger 104 is located outside the air conditioning case 150 and exchanges heat between the refrigerant and the outdoor air.

The first expansion valve 103 is positioned between the compressor 111 and the outdoor heat exchanger 104 to selectively expand the refrigerant or to make the refrigerant bypass. That is, the first expansion valve 103 directly passes the refrigerant without expansion of the refrigerant in a cooling mode, but expands the refrigerant in a heating mode. The water-cooled condenser 102 is arranged between the compressor 111 and the first expansion valve 103. As described above, the first expansion valve 103 selectively performs a refrigerant expansion function and a refrigerant bypass function.

The second expansion valve 106 is arranged between the outdoor heat exchanger 104 and the indoor heat exchanger 107 to selectively expand the refrigerant or to change the direction of the refrigerant toward a chiller 252. The chiller 252 is arranged between the second expansion valve 106 and the compressor 111 to exchange heat between cooling water of the second cooling water line 250 and refrigerant of a refrigerant line 110. The refrigerant passing through the outdoor heat exchanger 104 sequentially passes through the second expansion valve 106 and the indoor heat exchanger 107 and circulates to the compressor 111, or passes through the chiller 252 and circulates to the compressor 111.

That is, the second expansion valve 106 expands the refrigerant in the cooling mode, does not expand the refrigerant in the heating mode, and changes the direction of the refrigerant so that the refrigerant bypasses the indoor heat exchanger 107 and passes through the chiller 252. As described above, the second expansion valve 106 selectively performs the refrigerant expansion function and a refrigerant direction switching function. Additionally, in a dehumidification mode, the second expansion valve 106 expands some of the refrigerant and changes the direction of the remainder of the refrigerant toward the chiller 252.

The indoor heat exchanger 107 and the heater core 205 are sequentially arranged inside the air conditioning case 150 in the air flow direction. A blower unit for blowing air toward an air inlet of the air conditioning case 150 is provided. The heater core 205 exchanges heat with the air passing through the heater core 205 to heat the air. A temperature door 151 for controlling the temperature of the air being discharged into the interior of the vehicle is provided between the indoor heat exchanger 107 and the heater core 205. The temperature door 151 adjusts the amount of air between a cold air passage and a warm air passage as rotating within the air conditioning case 150.

The outdoor heat exchanger 104, the electric radiator 253, and the engine radiator 202 are positioned at the front side of the vehicle to exchange heat with the outdoor air, and a separate blowing fan may be provided for efficient heat exchange. Meanwhile, an internal heat exchanger 105 may be provided upstream of the second expansion valve 106 and downstream of the indoor heat exchanger 107 in the refrigerant flow direction.

A first cooling water line 211 circulates through an engine 201, an engine radiator 202, and the heater core 205. The cooling water circulating through the heater core 205 exchanges heat with the air being discharged into the interior within the air conditioning case 150. The second cooling water line 250 circulates through the electric components 251 and the electric radiator 253. Moreover, the first cooling water line 211 is connected to an engine line 210 passing through the engine 201, and the water-cooled condenser 102 is arranged in parallel to the engine 201 and the heater core 205.

The heat pump system for the vehicle includes a valve part. The valve part functions to connect or disconnect the first cooling water line 211 and the second cooling water line 250. The valve part includes a first three-way valve 204 and a second three-way valve 206. The first three-way valve 204 allows or blocks the flow of the cooling water from the second cooling water line 250 into the first cooling water line 211. The second three-way valve 206 allows or blocks the flow of cooling water from the first cooling water line 211 into the second cooling water line 250.

The water-cooled condenser 102 is provided between the compressor 111 and the outdoor heat exchanger 104, and exchanges heat between the refrigerant and the engine heat of the first cooling water line 211 or the electric heat of the second cooling water line 250. The water-cooled condenser 102 is connected in parallel to the engine 201. The chiller 252 is positioned upstream of the compressor 111 in the refrigerant flow direction, and exchanges heat between the refrigerant and the electric heat of the second cooling water line 250.

That is, the cooling water passing through the heater core 205 bypasses the engine 201, passes only through the water-cooled condenser 102, and then circulates through the heater core 205. Alternatively, the cooling water passing through the heater core 205 bypasses the water-cooled condenser 102, passes only through the engine 201, and then, circulates through the heater core 205. Alternatively, the cooling water passing through the heater core 205 passes through both the engine 201 and the water-cooled condenser 102, and then, circulates through the heater core 205.

The heat pump system for the vehicle also includes a third three-way valve 203 and a fourth three-way valve 208. The third three-way valve 203 is provided downstream of the first three-way valve 204 in the cooling water flow direction, and directs the cooling water passing through the first three-way valve 204 to the engine 201 or to the water-cooled condenser 102. The fourth three-way valve 208 is provided upstream of the second three-way valve 206 in the cooling water flow direction. The fourth three-way valve 208 makes the cooling water passing through the engine 201 flow to the second three-way valve 206, or makes the cooling water passing through the water-cooled condenser 102 flow to the second three-way valve 206.

The first three-way valve 204 branches off between the electric radiator 253 and the electric components 251, and is connected between the heater core 205 and the third three-way valve 203 in the first cooling water line 211. Additionally, the second three-way valve 206 branches off between the fourth three-way valve 208 and the heater core 205, and is connected between the chiller 252 and the electric radiator 253 in the second cooling water line 250.

Meanwhile, the heat pump system for the vehicle further includes a fifth three-way valve 254. The fifth three-way valve 254 is installed on the second cooling water line 250, and controls the flow of the cooling water passing through the chiller 252 to pass through or bypass the electric radiator 253.

That is, the cooling water passing through the electric components 251 and the chiller 252 circulates through the electric components 251 after bypassing the electric radiator 253 by the control of the fifth three-way valve 254 and passing through the water pump 255, or circulates through the electric components 251 after sequentially passing the electric radiator 253 and the water pump 255.

In more detail, the engine radiator 202, the fourth three-way valve 208, the water pump 207, the second three-way valve 206, the heater core 205, the first three-way valve 204, and the third three-way valve 203 are sequentially arranged in the first cooling water line 211 in a cooling water flow direction. Moreover, the engine line 210 passing through the engine 201 is connected upstream and downstream of the engine radiator 202, so that the cooling water passing through the engine 201 flows through the engine radiator 202 as well. Additionally, a thermostat 209 may be equipped in the first cooling water line 211.

The cooling water passing through the heater core 205 goes through the first three-way valve 204 and the third three-way valve 203, passes through the engine 201 and the engine radiator 202, goes through the fourth three-way valve 208 and the second three-way valve 206, and then, circulates through the heater core 205. Alternatively, the cooling water passing through the heater core 205 goes through the first three-way valve 204 and the third three-way valve 203, bypasses the engine 201 and the engine radiator 202, passes through the water-cooled condenser 102, and then, goes through the fourth three-way valve 208 and the second three-way valve 206, and then, circulates through the heater core 205. Alternatively, the cooling water passing through the heater core 205 goes through the first three-way valve 204 and the third three-way valve 203, and some of the cooling water passes through the engine 201 and the engine radiator 202, and the remainder of the cooling water passes through the water-cooled condenser 102, and then, goes through the fourth three-way valve 208 and the second three-way valve 206, and then, circulates through the heater core 205.

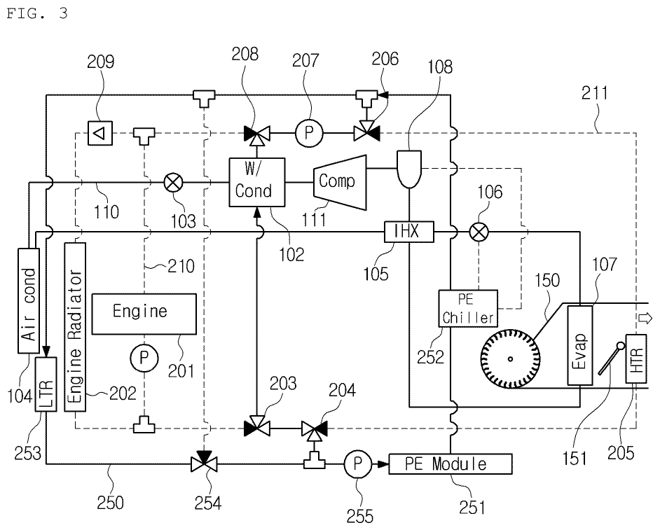

Referring to FIG. 3, in the cooling mode, when the engine is off, the first cooling water line 211 and the second cooling water line 250 are connected to each other by the control of the first three-way valve 204 and the second three-way valve 206, such that the water-cooled condenser 102 is cooled using the electric radiator 253.

Namely, the high-temperature and high-pressure refrigerant discharged from the compressor 111 is primarily cooled by the cooling water in the water-cooled condenser 102, passes directly through the first expansion valve 103, and then, is secondarily cooled by the outdoor air in the outdoor heat exchanger 104. Thereafter, the secondarily cooled refrigerant is expanded in the second expansion valve 106, and then, exchanges heat with the indoor air while passing through the indoor heat exchanger 107, thereby cooling the interior.

Additionally, the cooling water passing through the electric components 251 goes through the chiller 252 and the electric radiator 253, and circulates through the electric components 251. Some of the cooling water passing through the electric radiator 253 flows into the first cooling water line 211 after passing through the first three-way valve 204, and then, passes through the water-cooled condenser 102 after going through the third three-way valve 203. The cooling water passing through the water-cooled condenser 102 exchanges heat with the refrigerant discharged from the compressor 111. The cooling water passing through the water-cooled condenser 102 passes through the fourth three-way valve 208, and then, flows into the second cooling water line 250 through the second three-way valve 206.

The water-cooled condenser 102 exchanges heat with the refrigerant using the engine heat from the first cooling water line 211 or the electric heat from the second cooling water line 250, so the refrigerant discharged from the compressor 111 in the cooling mode is primarily cooled in the water-cooled condenser 102 and secondarily cooled in the outdoor heat exchanger 104.

As described above, the high-temperature refrigerant discharged from the compressor 111 is primarily cooled in the water-cooled condenser 102 using a water-cooling method and secondarily cooled in the outdoor heat exchanger 104 using an air-cooling method, thereby enhancing the cooling performance. Moreover, since the heater core 205 is not operated, sufficient cooling performance can be secured even though the compressor 111 operate at low rotation speed without heat pick-up. That is, since the refrigerant is primarily cooled in the water-cooled condenser 102 and then secondarily cooled in the outdoor heat exchanger 104, the cooling performance is enhanced, and since cooling water does not flow into the heater core 205, there is no heat pick-up, thereby maximizing the cooling performance.

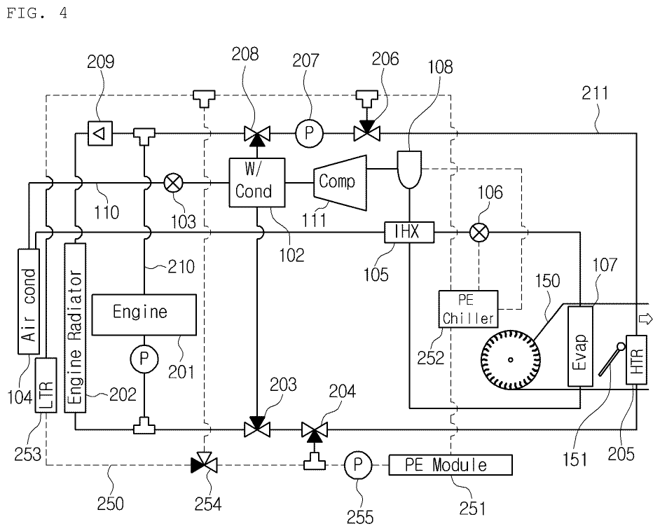

Referring further to FIG. 4, in the cooling mode, during the initial operation of the engine, the water-cooled condenser 102 is cooled using the cooling water circulating through the engine 201 in the first cooling water line 211, so cooling is performed using the water-cooled condenser 102 and the outdoor heat exchanger 104.

Namely, the high-temperature and high-pressure refrigerant discharged from the compressor 111 is primarily cooled by the cooling water in the water-cooled condenser 102, and then, passes directly through the first expansion valve 103. Thereafter, the refrigerant is secondarily cooled by the outdoor air in the outdoor heat exchanger 104, is expanded at the second expansion valve 106, and then, exchanges heat with the indoor air while passing through the indoor heat exchanger 107, thereby cooling the interior.

The cooling water passing through the heater core 205 flows through the third three-way valve 203 after passing through the first three-way valve 204. Thereafter, some of the cooling water passes through the engine 201 and the engine radiator 202, and the remainder of the cooling water passes through the water-cooled condenser 102, goes through the fourth three-way valve 208 and the second three-way valve 206, and then, circulates through the heater core 205. In this case, the flow of cooling water in the second cooling water line 250 is stopped. As described above, during the initial operation of the engine 201, the water-cooled condenser 102 is cooled by using the engine cooling water.

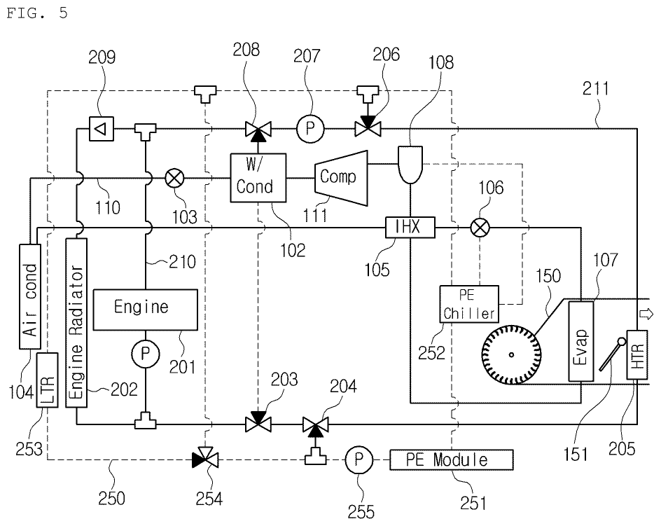

Referring further to FIG. 5, in the cooling mode, when the engine is operating, the flow passage of the water-cooled condenser 102 is blocked, and cooling is performed using only the outdoor heat exchanger 104.

That is, the high-temperature and high-pressure refrigerant discharged from the compressor 111 is primarily cooled by the cooling water in the water-cooled condenser 102, and then, secondarily cooled by the outdoor air in the outdoor heat exchanger 104 after passing directly through the first expansion valve 103. Thereafter, the refrigerant is expanded at the second expansion valve 106, and then exchanges heat with the indoor air while passing through the indoor heat exchanger 107, thereby cooling the interior.

The cooling water passing through the heater core 205 passes through the engine 201 and the engine radiator 202 after sequentially passing through the first three-way valve 204 and the third three-way valve 203. Thereafter, the cooling water passes through the fourth three-way valve 208 and the second three-way valve 206, and then, circulates through the heater core 205. In this case, the flow of the cooling water in the second cooling water line 250 is stopped, and the cooling water does not flow through the water-cooled condenser 102.

As described above, after the engine 201 has operated for a specific period and has warmed up, the flow passage of the water-cooled condenser 102 is blocked, and the cooling water flows to the heater core 205. Finally, until the cooling water is heated, cooling is performed using both the water-cooled condenser 102 and the outdoor heat exchanger 104, thereby enhancing the rapid cooling effectiveness. After the cooling water heats up, the cooling water does not flow to the water-cooled condenser 102, and cooling is performed using only the outdoor heat exchanger 104.

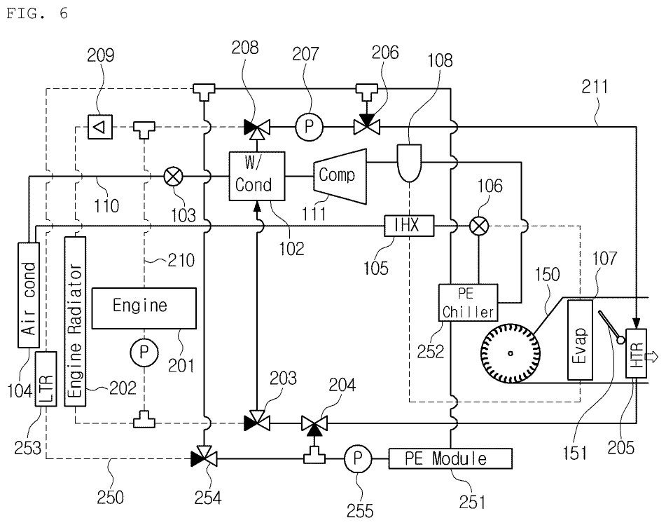

Referring to FIG. 6, in the heating mode, when the engine is off, the first cooling water line 211 and the second cooling water line 250 are separated from each other by the control of the first three-way valve 204 and the second three-way valve 206. The cooling water in the first cooling water line 211, heated by the refrigerant in the water-cooled condenser 102, is supplied to the heater core 205 to perform heating, and the cooling water in the second cooling water line 250, passing through the electric components 251, is cooled in the chiller 252.

Namely, the high-temperature and high-pressure refrigerant discharged from the compressor 111 is cooled by the cooling water in the water-cooled condenser 102, and is expanded at the first expansion valve 103. The expanded refrigerant passes through the outdoor heat exchanger 104, changes the direction at the second expansion valve 106 to pass through the chiller 252, and then circulates through the compressor 111. In this case, the refrigerant does not flow to the indoor heat exchanger 107.

The cooling passing through the electric components 251 passes through the chiller 252, bypasses the electric radiator 253 by the control of the fifth three-way valve 254, and then, circulates through the electric components 251. Additionally, the cooling water passing through the heater core 205 goes through the first three-way valve 204 and the third three-way valve 203, passes through the water-cooled condenser 102, passes through the fourth three-way valve 208 and the second three-way valve 206, and then, circulates through the heater core 205. The cooling water passing through the heater core 205 exchanges heat with the indoor air to heat the interior.

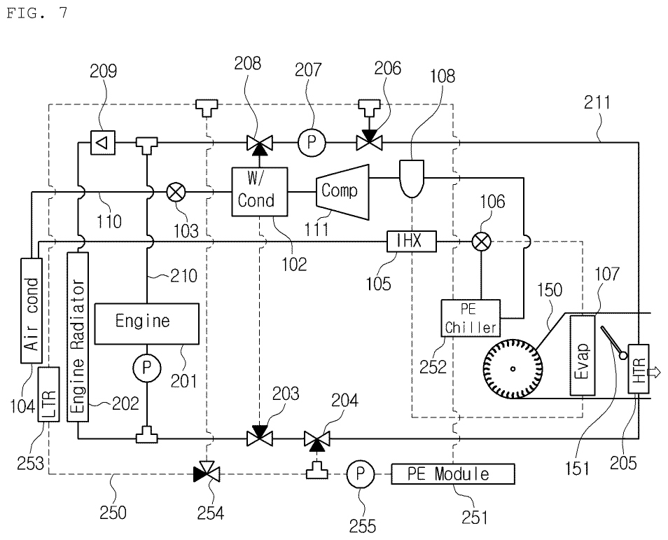

Referring to FIG. 7, in the heating mode, when the engine is operating, the first cooling water line 211 and the second cooling water line 250 are separated from each other by the control of the first three-way valve 204 and the second three-way valve 206, so the cooling water in the first cooling water line 211, heated by the engine 201, is supplied to the heater core 205 to perform heating.

That is, the high-temperature and high-pressure refrigerant discharged from the compressor 111 is cooled by the cooling water in the water-cooled condenser 102, and is expanded at the first expansion valve 103. The expanded refrigerant passes through the outdoor heat exchanger 104, changes the direction at the second expansion valve 106 to pass through the chiller 252, and then circulates through the compressor 111. In this case, the refrigerant does not flow to the indoor heat exchanger 107.

The cooling water passing through the heater core 205 passes through the engine 201 and the engine radiator 202 after going through the first three-way valve 204 and the third three-way valve 203, and then circulates through the heater core 205 after passing through the fourth three-way valve 208 and the second three-way valve 206. The cooling water passing through the heater core 205 exchanges heat with the indoor air to heat the interior. In this case, the cooling water does not flow to the water-cooled condenser 102, and the flow of cooling water in the second cooling water line 250 is also stopped.

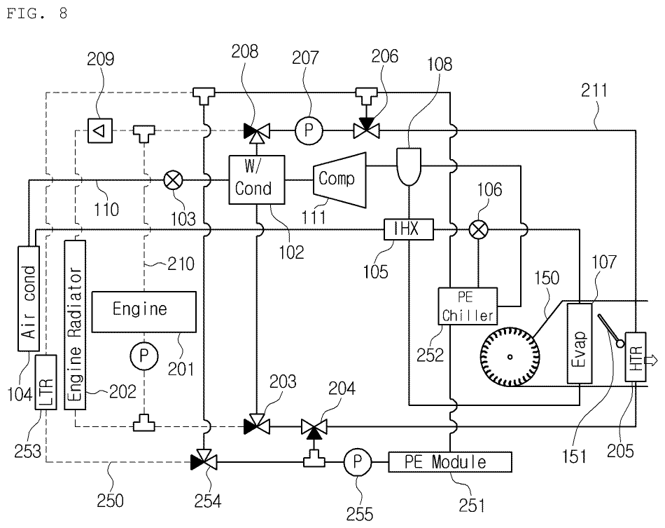

Referring to FIG. 8, in the dehumidification mode, when the engine is off, the first cooling water line 211 and the second cooling water line 250 are separated from each other by the control of the first three-way valve 204 and the second three-way valve 206, so the cooling water in the first cooling water line 211, heated by the refrigerant in the water-cooled condenser 102, is supplied to the heater core 205 to perform heating, and the cooling water in the second cooling water line 250, passing through the electric components 251, is cooled in the chiller 252.

Moreover, the high-temperature and high-pressure refrigerant discharged from the compressor 111 is cooled by the cooling water in the water-cooled condenser 102, is expanded at the first expansion valve 103, and then, passes through the outdoor heat exchanger 104. Thereafter, some of the refrigerant changes the direction at the second expansion valve 106, passes through the chiller 252, and then, circulates through the compressor 111. In addition, the remainder of the refrigerant passing through the outdoor heat exchanger 104 is expanded at the second expansion valve 106, is evaporated in the indoor heat exchanger 107, and circulates through the compressor 111, thereby performing dehumidification.

The cooling water passing through the electric components 251 passes through the chiller 252, bypasses the electric radiator 253 by the control of the fifth three-way valve 254, and then, circulates through the electric components 251. Moreover, the cooling water passing through the heater core 205 passes through the water-cooled condenser 102 after going through the first three-way valve 204 and the third three-way valve 203, and then, circulates through the heater core 205 after going through the fourth three-way valve 208 and the second three-way valve 206. The cooling water passing through the heater core 205 exchanges heat with the indoor air to heat the interior.

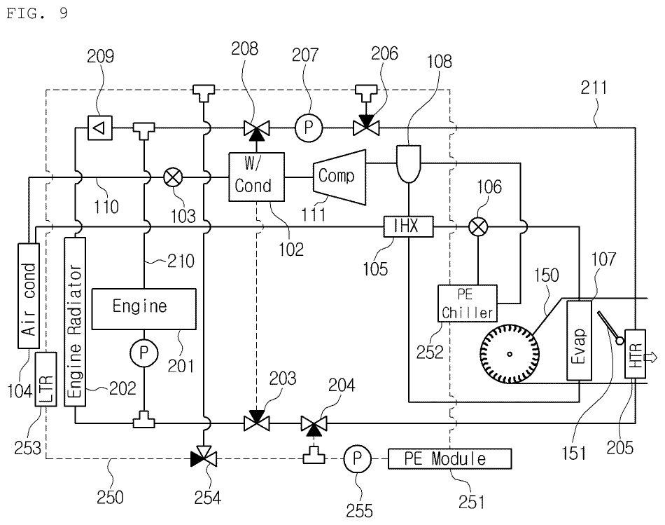

Referring to FIG. 9, in the dehumidification mode, when the engine is operating, the first cooling water line 211 and the second cooling water line 250 are separated from each other by the control of the first three-way valve 204 and the second three-way valve 206, so the cooling water in the first cooling water line 211, heated by the engine 201, is supplied to the heater core 205 to perform heating.

Additionally, the high-temperature and high-pressure refrigerant discharged from the compressor 111 is cooled by the cooling water in the water-cooled condenser 102, is expanded at the first expansion valve 103, and then passes through the outdoor heat exchanger 104. Some of the refrigerant changes the direction at the second expansion valve 106, passes through the chiller 252, and then, circulates through the compressor 111. Additionally, the remainder of the refrigerant passing through the outdoor heat exchanger 104 is expanded at the second expansion valve 106, is evaporated in the indoor heat exchanger 107, and then, circulates through the compressor 111 to perform dehumidification.

The cooling water passing through the heater core 205 passes through the engine 201 and the engine radiator 202 after going through the first three-way valve 204 and the third three-way valve 203, and then, circulates through the heater core 205 after going through the fourth three-way valve 208 and the second three-way valve 206. The cooling water passing through the heater core 205 exchanges heat with the indoor air to heat the interior. In this case, the cooling water does not flow to the water-cooled condenser 102, and the flow of the cooling water in the second cooling water line 250 is also stopped.

The heat pump system for the vehicle according to an embodiment of the present invention can heat the interior of a hybrid vehicle without operation of the engine in low-temperature environments by applying the heat pump system to the hybrid vehicle, improve fuel efficiency, reduce carbon dioxide emissions, and enhance the thermal comfort of passengers inside. Additionally, by integrating the existing air conditioner using the heater core and the heat pump system, the heat pump system for the vehicle according to an embodiment of the present invention can effectively heat the interior even in low-temperature environments as cold as −30° C. since switching to heating using cooling water when the engine is operated.

In addition, the heat pump system has good cooling efficiency by cooling the water-cooled condenser using cooling water of the PE module (electric components) due to the condenser configured to be both air-cooled and water-cooled, and is highly advantageous in terms of cost reduction and vehicle packaging since considerably reducing the size of the air-cooled condenser (outdoor heat exchanger) compared to the existing heat pump system.

To sum up, the heat pump system for the vehicle according to an embodiment of the present invention by configuring a water-cooled condenser, in a heating mode can recover waste heat from electric components, which is worthless as heat, to operate the heat pump system. The system operates as a heat pump system to heat the interior in the initial stage in low temperature environments, and when the engine temperature increases over time, can perform hybrid air conditioning operation to perform heating using the heater core. Therefore, while conventional heat pump systems can only operate at outdoor air temperature of −20° C., but the heat pump system according to the present invention can effectively provides heating even in extremely cold environments of −30° C.

In addition, the air-cooled condenser (outdoor heat exchanger) can be reduced to about half in size compared to the conventional condenser, so is advantageous in packaging of a vehicle and can be integrated or stacked with the electric radiator. Furthermore, the air-cooled condenser operates by recovering waste heat from the electric components through the chiller, thereby improving air conditioning efficiency and enabling frost prevention operations. The water-cooled condenser provides heated cooling water to the interior by heating the cooling water in the heating mode, and performs the function to cool the refrigerant in the cooling mode.

While the heat pump system for the vehicle of the present invention has been described with reference to the illustrated embodiments, the descriptions are exemplary only, and it will be understood by those skilled in the art that various modifications and equivalents of the embodiments are possible. Therefore, the true technical protection scope should be defined by the technical spirit of the appended claims.

1. A heat pump system for a vehicle comprising:
a refrigerant line which circulates through a compressor, an outdoor heat exchanger, an expansion means, and an indoor heat exchanger, and in which refrigerant circulating through the indoor heat exchanger exchanges heat with air discharged to the interior;
a first cooling water line which circulates through an engine and a heater core, and in which cooling water circulating through the heater core exchanges heat with air discharged to the interior; and
a second cooling water line which circulates through electric components and an electric radiator,
wherein a valve part for connecting or separating the first cooling water line and the second cooling water line is provided.

2. The heat pump system according to claim 1, wherein the valve part comprises:
a first three-way valve which allows or blocks the flow of cooling water from the second cooling water line to the first cooling water line; and
a second three-way valve which allows or blocks the flow of cooling water from the first cooling water line to the second cooling water line.

3. The heat pump system according to claim 2, further comprising:
a water-cooled condenser which is provided between the compressor and the outdoor heat exchanger to exchange heat between the refrigerant and either the engine heat from the first cooling water line or the electric heat from the second cooling water line; and
a chiller which is provided upstream of the compressor in a refrigerant flow direction to exchange heat between the refrigerant and the electric heat from the second cooling water line.

4. The heat pump system according to claim 3, wherein the water-cooled condenser is arranged parallel to the engine and the heater core.

5. The heat pump system according to claim 3, comprising:
a third three-way valve which is provided downstream of the first three-way valve in a cooling water flow direction to allow the cooling water passing through the first three-way valve to flow to the engine or the water-cooled condenser; and
a fourth three-way valve which is provided upstream of the second three-way valve in the cooling water flow direction to allow cooling water passing through the engine to flow to the second three-way valve or allow cooling water passing through the water-cooled condenser to flow to the second three-way valve.

6. The heat pump system according to claim 5, wherein the first three-way valve branches off between the electric radiator and the electric components and is connected between the heater core and the third three-way valve in the first cooling water line, and
wherein the second three-way valve branches off between the fourth three-way valve and the heater core and is connected between the chiller and the electric radiator in the second cooling water line.

7. The heat pump system according to claim 3, further comprising:
a first expansion valve which selectively makes the refrigerant expand or bypass between the compressor and the outdoor heat exchanger,
wherein the water-cooled condenser is positioned between the compressor and the first expansion valve.

8. The heat pump system according to claim 7, further comprising:
a second expansion valve which selectively makes the refrigerant expand between the outdoor heat exchanger and the indoor heat exchanger or change the direction toward the chiller,
wherein the chiller is arranged between the second expansion valve and the compressor, so the refrigerant passing through the outdoor heat exchanger circulates through the compressor after sequentially passing through the second expansion valve and the indoor heat exchanger or circulates through the compressor after passing through the chiller.

9. The heat pump system according to claim 5, further comprising:
a fifth three-way valve which controls the cooling water passing through the chiller in the second cooling water line to selectively pass through or bypass the electric radiator.

10. The heat pump system according to claim 3, wherein in a cooling mode, when the engine is off, the first cooling water line and the second cooling water line are connected by the control of the first three-way valve and the second three-way valve, so the water-cooled condenser is cooled using the electric radiator.

11. The heat pump system according to claim 3, wherein in the cooling mode, at the initial operation of the engine, the water-cooled condenser is cooled using the cooling water circulating through the engine in the first cooling water line, so cooling is performed using the water-cooled condenser and the outdoor heat exchanger, and
wherein in the cooling mode, when the engine is operating, the flow passage of the water-cooled condenser is blocked, so cooling is performed using only the outdoor heat exchanger.

12. The heat pump system according to claim 3, wherein in a heating mode, when the engine is off, the first cooling water line and the second cooling water line are separated from each other by the control of the first three-way valve and the second three-way valve, so the cooling water in the first cooling water line, heated by the refrigerant in the water-cooled condenser, is supplied to the heater core to perform heating, and the cooling water in the second cooling water line, passing through the electric components, is cooled in the chiller.

13. The heat pump system according to claim 3, wherein in the heating mode, when the engine is operating, the first cooling water line and the second cooling water line are separated from each other by the control of the first three-way valve and the second three-way valve, so the cooling water in the first cooling water line, heated by the engine, is supplied to the heater core to perform heating.

14. The heat pump system according to claim 3, wherein in a dehumidification mode, when the engine is off, the first cooling water line and the second cooling water line are separated from each other by the control of the first three-way valve and the second three-way valve, so the cooling water in the first cooling water line, heated by the refrigerant in the water-cooled condenser, is supplied to the heater core to perform heating, and the cooling water in the second cooling water line, passing through the electric components, is cooled in the chiller, and
wherein the refrigerant in the refrigerant line, expanded by passing through the outdoor heat exchanger, is evaporated in the indoor heat exchanger and circulates through the compressor.

15. The heat pump system according to claim 3, wherein in the dehumidification mode, when the engine is operating, the first cooling water line and the second cooling water line are separated from each other by the control of the first three-way valve and the second three-way valve, so the cooling water in the first cooling water line, heated by the engine, is supplied to the heater core to perform heating, and
wherein the refrigerant in the refrigerant line, expanded by passing through the outdoor heat exchanger, is evaporated in the indoor heat exchanger and circulates through the compressor.

16. A heat pump system for a vehicle comprising:
a refrigerant line which circulates through a compressor, an outdoor heat exchanger, an expansion means, and an indoor heat exchanger, and in which refrigerant circulating through the indoor heat exchanger exchanges heat with air discharged to the interior;
a first cooling water line which circulates through an engine and a heater core, and in which cooling water circulating through the heater core exchanges heat with air discharged to the interior; and
a second cooling water line which circulates through electric components and an electric radiator,
wherein a water-cooled condenser is provided between the compressor and the outdoor heat exchanger, and the water-cooled condenser exchanges heat between the refrigerant and either the engine heat from the first cooling water line or the electric heat from the second cooling water line, so the refrigerant discharged from the compressor is primarily cooled in the water-cooled condenser and secondarily cooled in the outdoor heat exchanger during cooling.
